(19) United States
(12) Patent Application Publication
(10) Pub. No.: US 2018/0222725 A1
(43) Pub. Date: Aug. 9, 2018

(54) PEOPLE CONVEYOR, CONVEYING BAND AND CONVEYING ELEMENT OF A PEOPLE CONVEYOR

(71) Applicant: Otis Elevator Company, Farmington, CT (US)

(72) Inventors: Alexander Turek, Munchendorf (AT); Andreas Glueck, Vienna (AT)

(21) Appl. No.: 15/885,310

(22) Filed: Jan. 31, 2018

(30) Foreign Application Priority Data
Feb. 9, 2017 (EP) 17155390.2

(51) Int. Cl. B66B 23/12; B66B 23/10; B66B 23/14; B66B 23/02

(52) U.S. Cl. CPC B66B 23/12; B66B 23/10; B66B 23/24; B66B 23/024; B66B 23/026; B66B 23/145

(57) ABSTRACT

A conveying element (4) is employed in a conveying band (2) of a people conveyor (50) comprising at least one horizontal portion (81, 83, 85), includes a tread (6) and a riser (8). The conveying element (4) is configured such that the riser (8) at least partly forms an intermediate tread surface (74) in the at least one horizontal portion (81, 83, 85).

The invention relates to a people conveyor, to a conveying band for a people conveyor and to a conveying element which is employed in a conveying band of a people conveyor.

A people conveyor such as an escalator or a moving walkway typically comprises a band of conveying elements, such as pallets or steps, which are configured for conveying people, and a drive unit, which is configured for driving the band of conveying elements. Torque provided by the drive unit is transmitted to the band of conveying elements (conveying band) via transmission elements, which in particular may include chains and/or belts.

In a conventional people conveyor gaps are formed between adjacent conveying elements allowing the conveying elements to move with respect to each other. Due to wear these gaps may enlarge during the lifetime of the people conveyor. Enlarged gaps may deteriorate the safety and the riding comfort provided by the people conveyor.

It would be beneficial to provide a people conveyor comprising an improved conveying band which is less affected by gaps between adjacent conveying elements.

According to an exemplary embodiment of the invention a conveying element which is to be employed in a conveying band of a people conveyor comprises a tread and a riser. The conveying element is configured such that the riser at least partly forms an intermediate tread in the at least one horizontal portion of the conveying band. The riser in particular is rotatably connected to the tread and is configured to be rotatably connected to an adjacent conveying element, in particular to a tread of an adjacent conveying element.

Exemplary embodiments of the invention also include a conveying band comprising a plurality of conveying elements which are rotatably connected to each other.

A people conveyor according to an exemplary embodiment of the invention comprises at least one horizontal portion, at least one inclined portion and a conveying band according to an exemplary embodiment of the invention, which extends along the at least one horizontal portion and the at least one inclined portion.

In a conveying band according to an exemplary embodiment of the invention gaps between adjacent conveying elements can be reduced to a minimum such that these gaps are not critical any more in practice. In particular, there is no risk that these gaps become larger during the lifetime of the people conveyor due to wear. This improves the safety and the comfort of the ride. In particular, the risk that any items or parts of a human body are trapped within gaps of the conveying band is considerably reduced.

A conveying band according to exemplary embodiments of the invention further allows for new people conveyor designs, in particular including arbitrary combinations of ascending, descending and horizontal portions of the people conveyor.

In the following, people conveyors according to exemplary embodiments of the invention are described with reference to the enclosed figures.

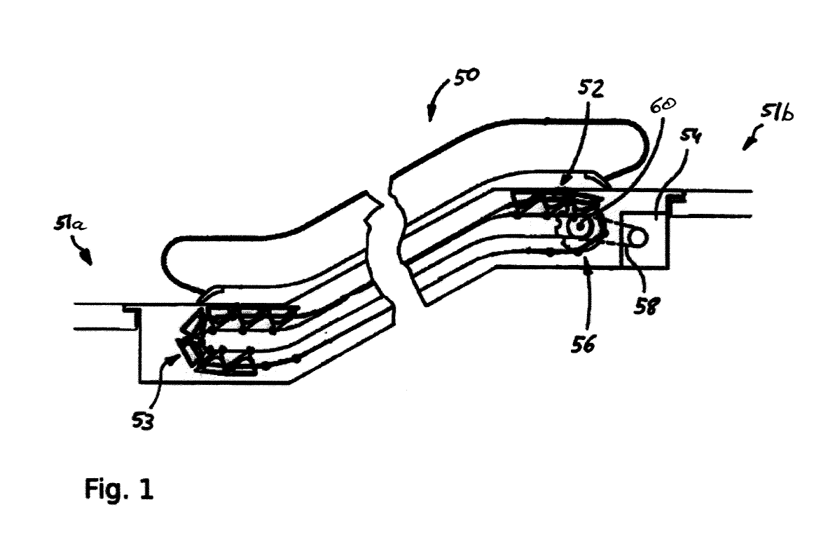

FIG. 1 shows a schematic side view of a conventional people conveyor.

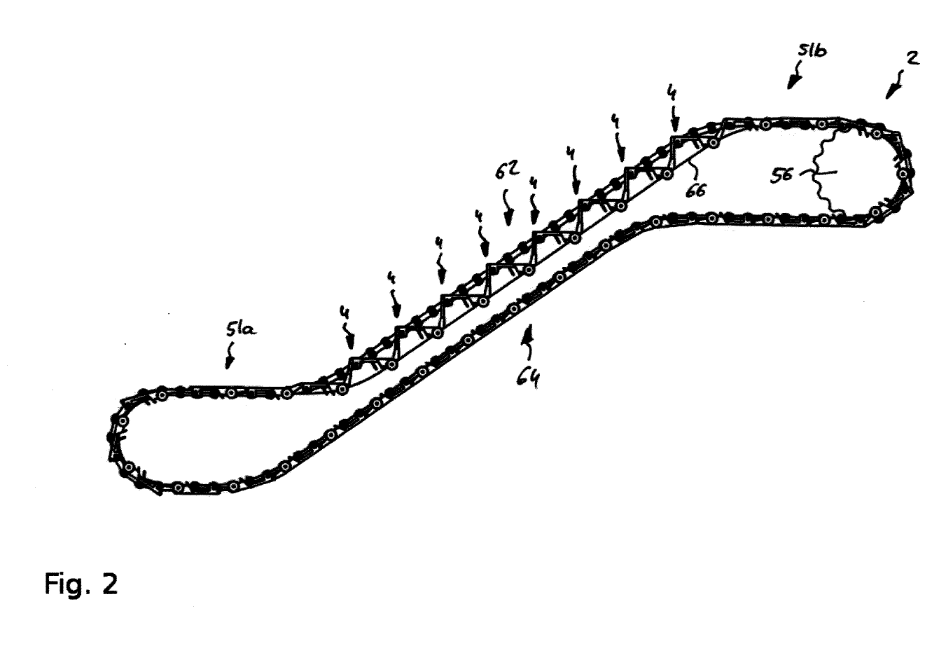

FIG. 2 shows a schematic side view of a conveying band (band of conveying elements) according to an exemplary embodiment of the invention.

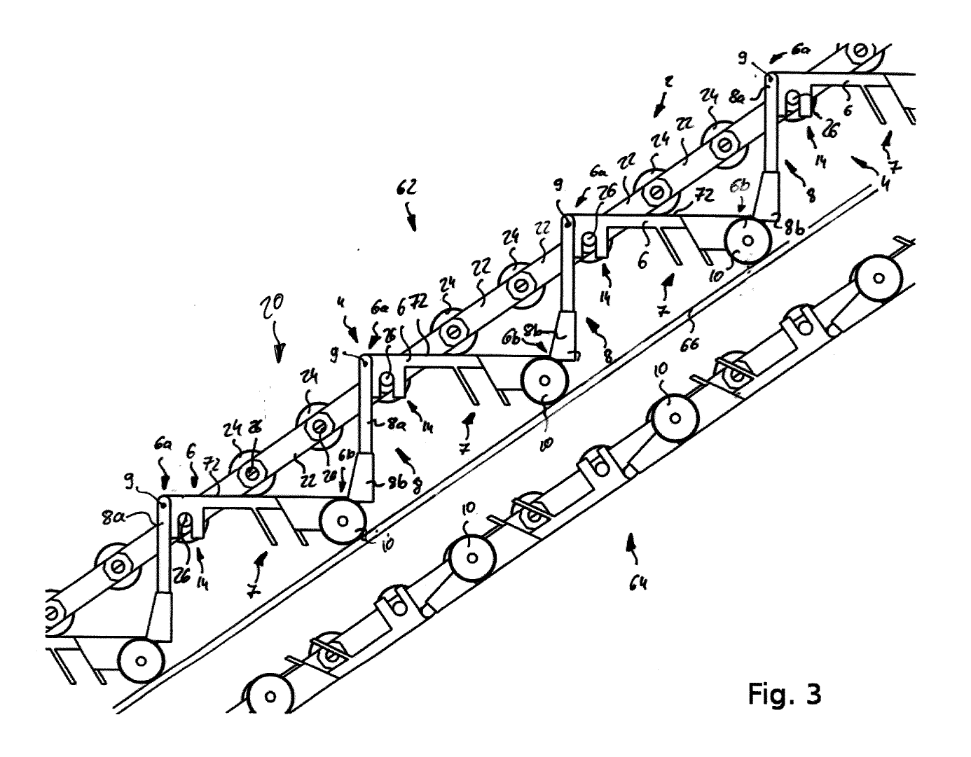

FIG. 3 shows an enlarged view of an inclined middle section of the conveying band shown in FIG. 2.

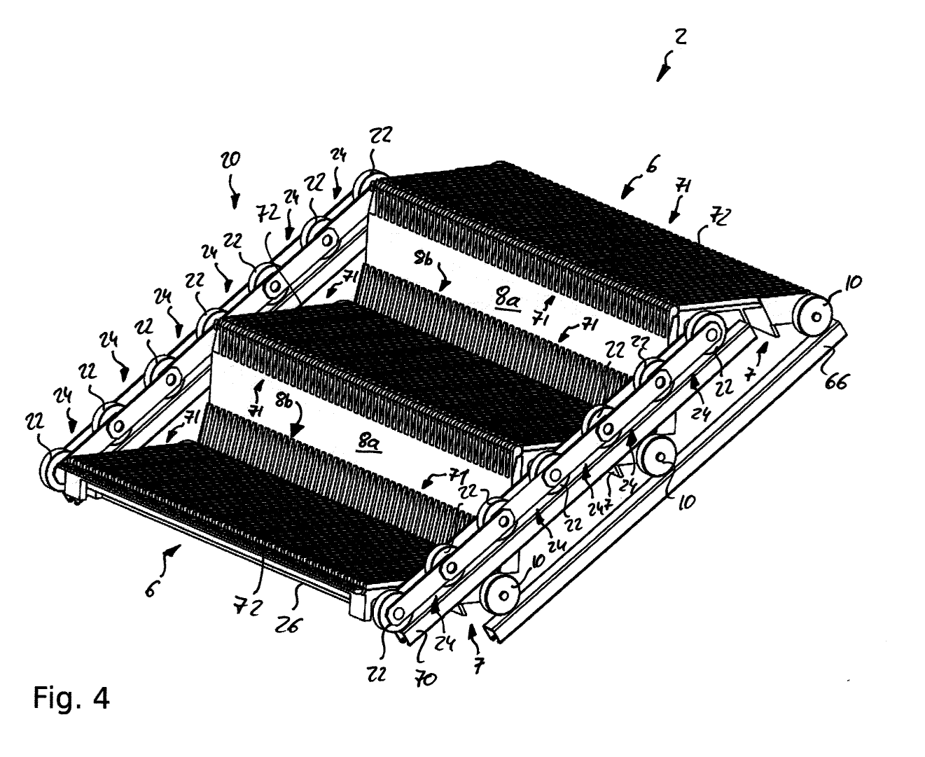

FIG. 4 shows a perspective view of a section of an inclined conveying portion of the conveying band shown in FIGS. 2 and 3.

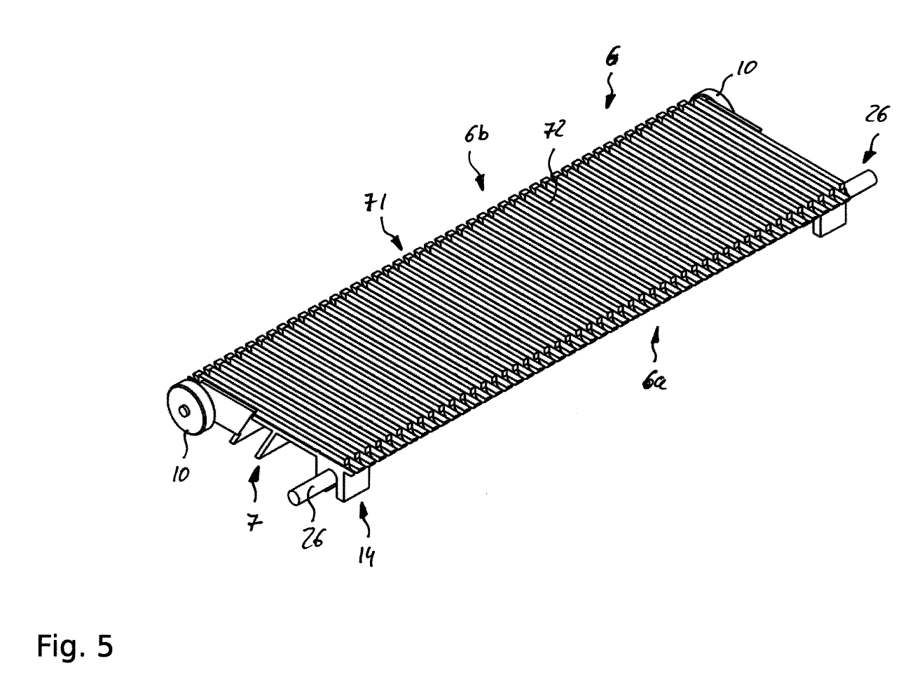

FIG. 5 shows a perspective view of a tread according to an exemplary embodiment of the invention.

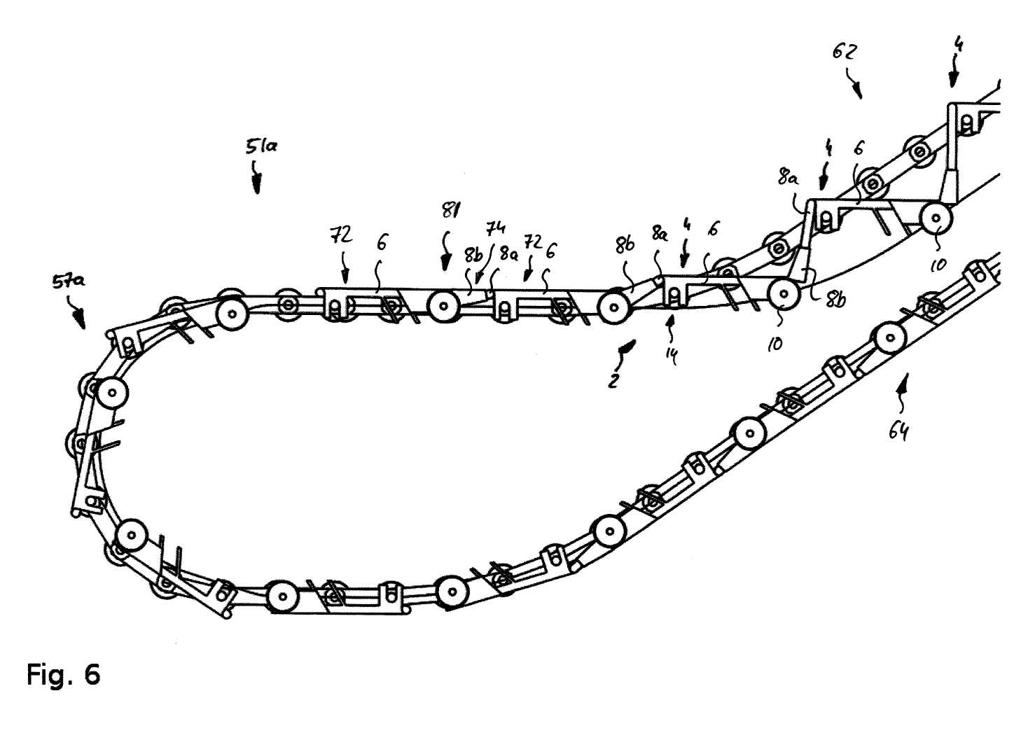

FIG. 6 shows a schematic side view of the conveying band according to an exemplary embodiment of the invention extending in a lower landing portion and an adjacent turnaround portion.

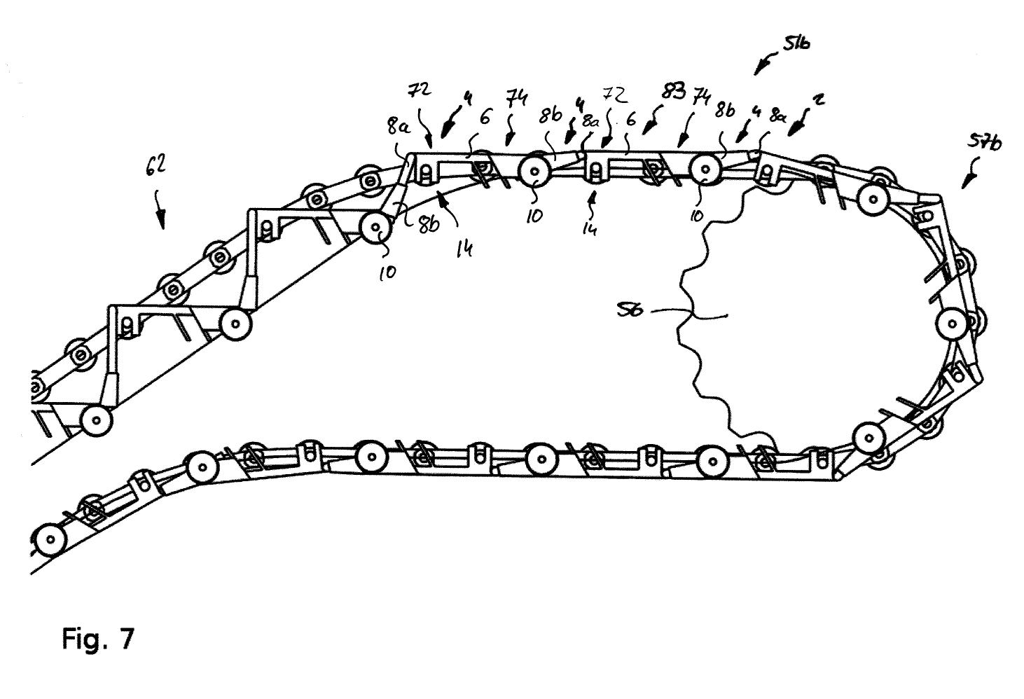

FIG. 7 shows a schematic side view of the conveying band according to an exemplary embodiment of the invention extending in an upper landing portion and an adjacent turnaround portion.

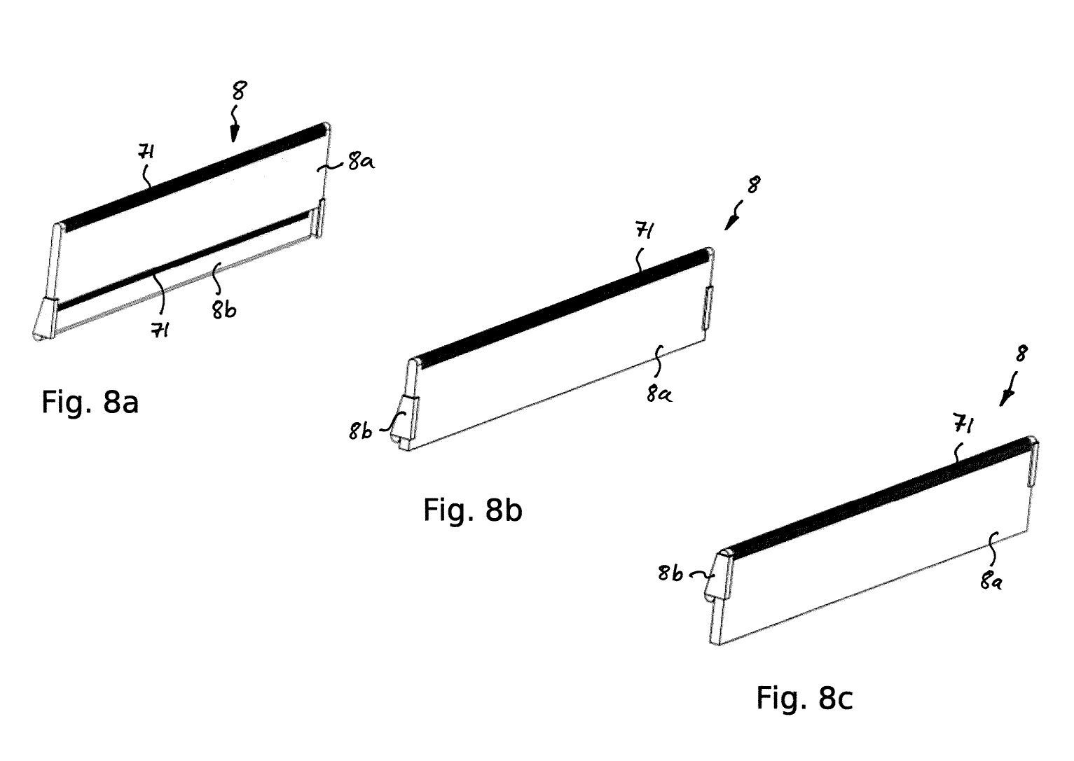

FIGS. 8a to 8c illustrate the movement of the second part of a riser with respect to the first part of the riser.

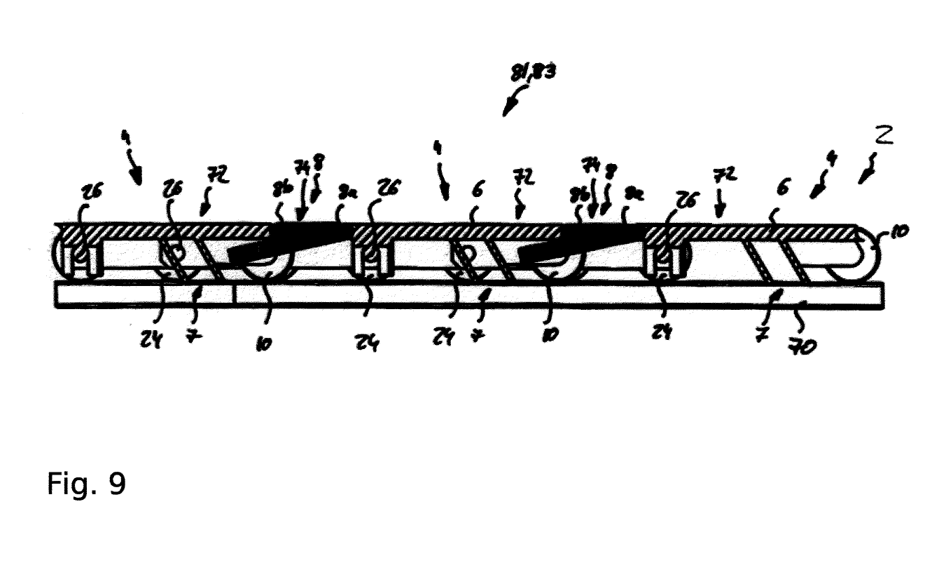

FIG. 9 shows a side view of the conveying band in a horizontal portion of the people conveyor.

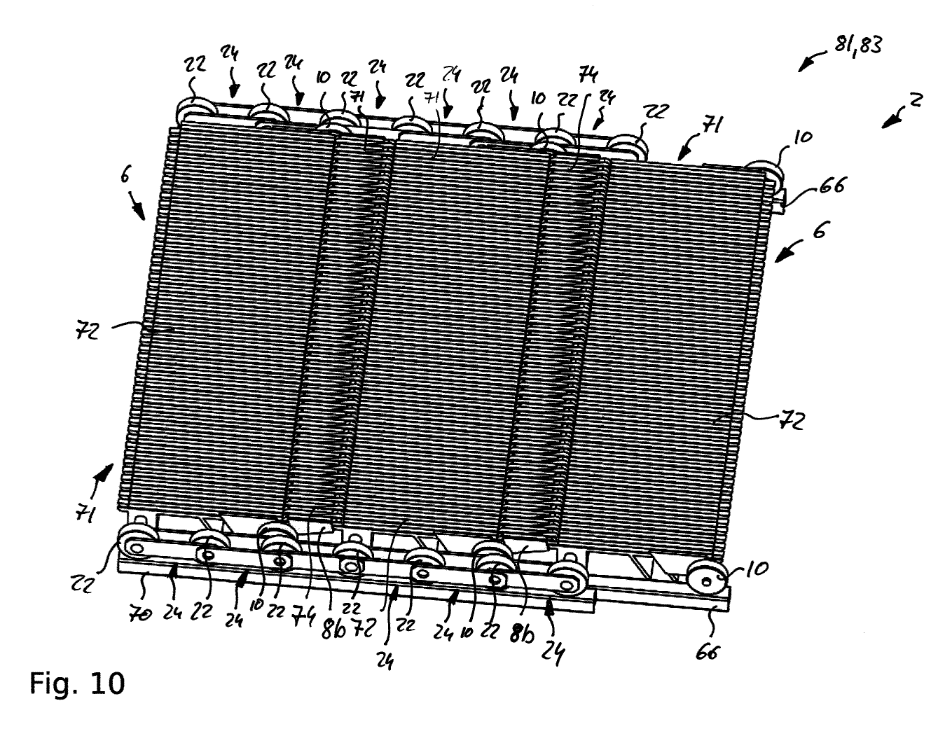

FIG. 10 shows a perspective view of the conveying band shown in FIG. 9.

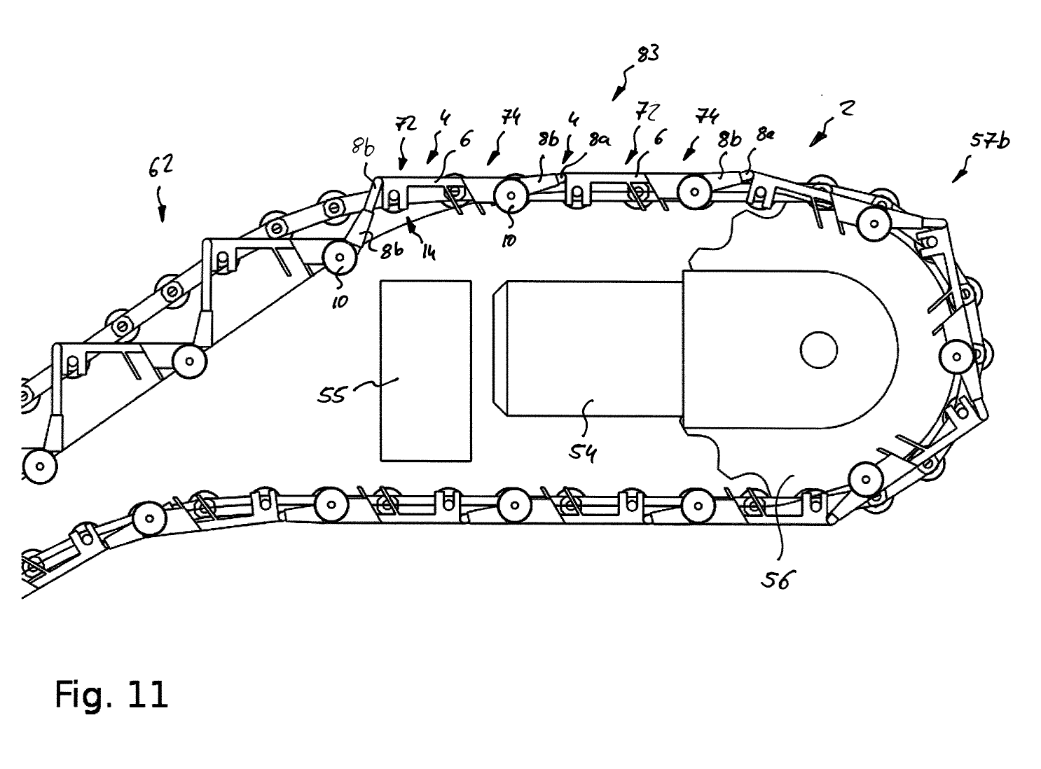

FIG. 11 shows a schematic side view of the conveying band according to an exemplary embodiment of the invention extending in an upper landing portion and an adjacent turnaround portion.

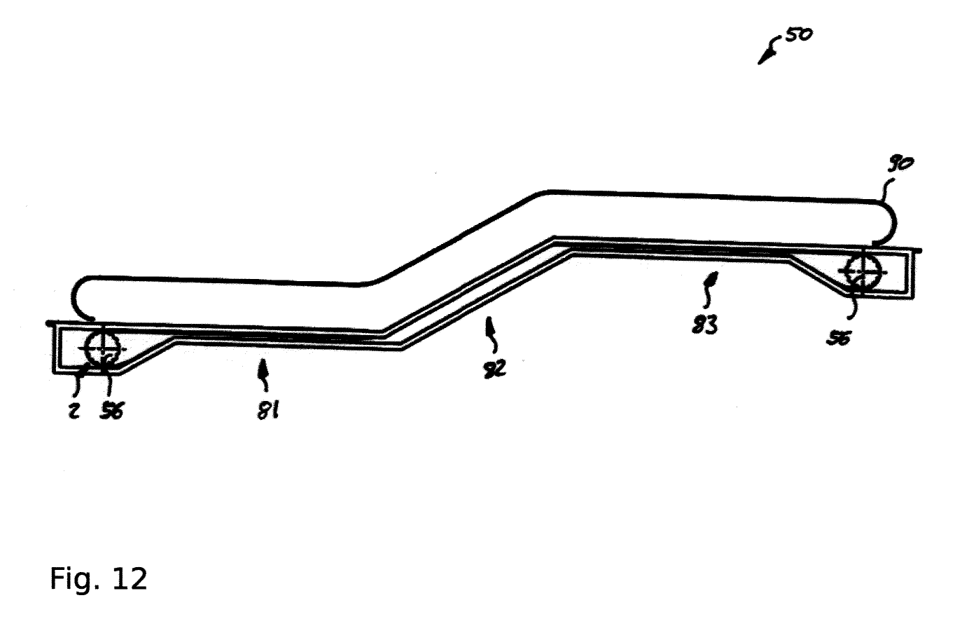

FIG. 12 shows a schematic side view of a people conveyor according to an exemplary embodiment of the invention which comprises two extended horizontal portions.

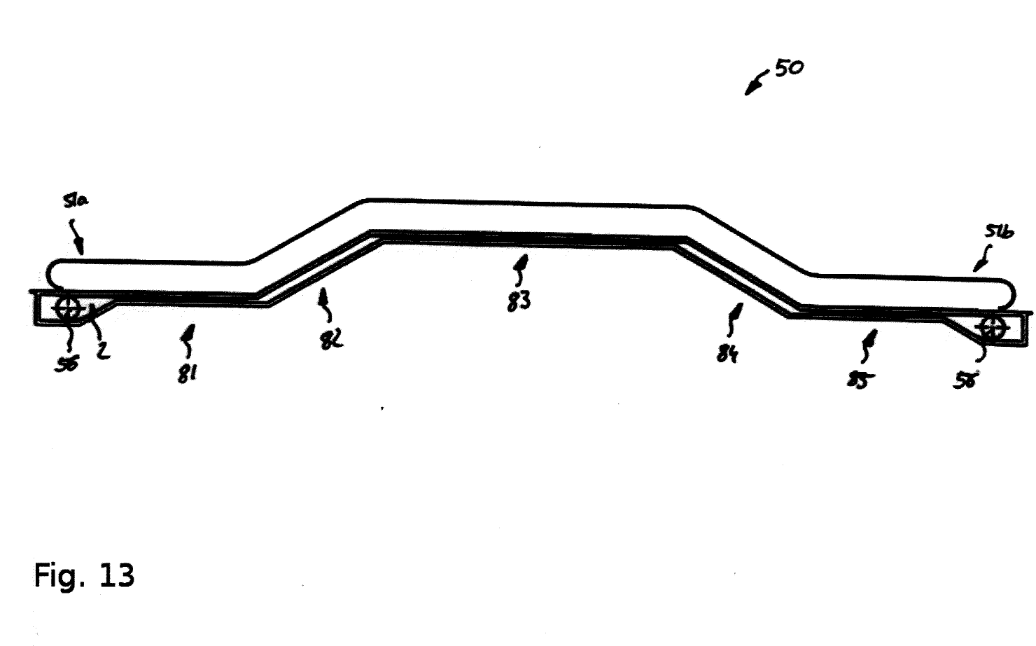

FIG. 13 shows a schematic side view of a people conveyor according to an exemplary embodiment of the invention which comprises two inclined portions and three horizontal portions.

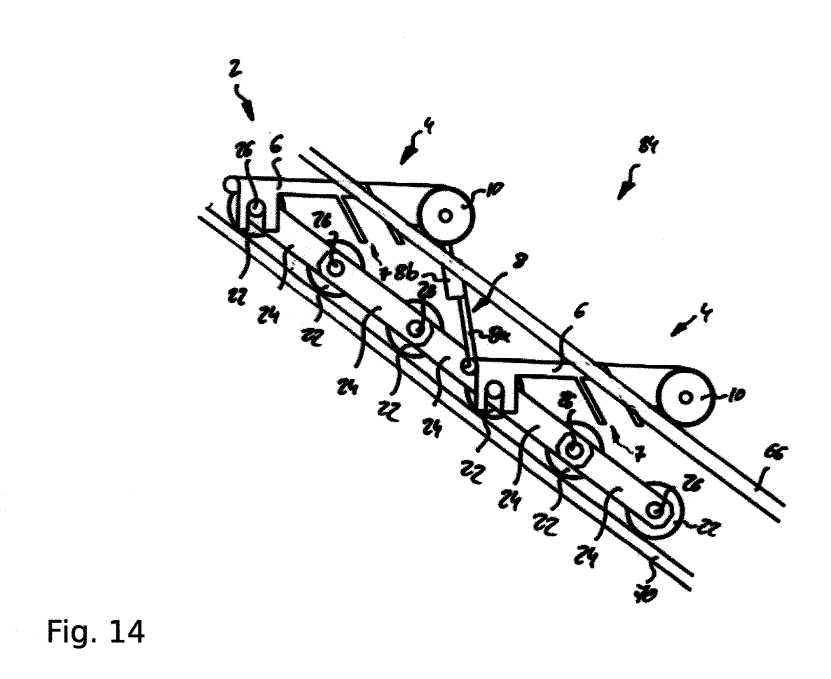

FIG. 14 illustrates the configuration of conveying elements according to an exemplary embodiment of the invention when arranged in a descending portion of a people conveyor.

FIG. 1 shows a schematic side view of a conventional people conveyor 50 comprising a conveying band 52 of a plurality of conveying elements 53, which extends between two landing portions 51a, 51b. In the embodiment shown in FIG. 1, the people conveyor 50 is an escalator and the conveying elements 53 are steps. The conveying band 52 is driven by a sprocket 56 which is mounted to a rotating shaft 60. A drive unit 54 is configured for driving the rotating shaft 60 and in consequence the sprocket 56 and the conveying band 52 via a transmission element 58, which may be a chain or belt.

FIG. 2 shows a schematic side view of a conveying band 2 comprising a plurality of conveying elements 4 according to an exemplary embodiment of the invention, and FIG. 3 shows an enlarged view of an inclined middle section of said conveying band 2. In particular, a section of an inclined conveying portion 62, which is configured for conveying passengers (not shown), is illustrated in the upper part of FIGS. 2 and 3, and a section of an inclined return portion 64 is illustrated in the lower part of FIGS. 2 and 3. FIG. 4 shows a perspective view of a section of the inclined conveying portion 62, and FIG. 5 shows a perspective view of a tread 6 of a conveying element 4 according to an exemplary embodiment of the invention.

A conveying band 2 according to an exemplary embodiment comprises a plurality of conveying elements 4 each of which comprises a tread 6, which is oriented basically horizontally when the conveying element 4 is arranged in the conveying portion 62. Each tread 6 is provided with a tread surface 72 on its upper side and a plurality of reinforcement ribs 7 on its bottom side.

Each conveying element 4 further comprises a riser 8, which is oriented basically perpendicularly to the tread 6 when the conveying element 4 is arranged in the inclined conveying portion 62.

Thus, when the conveying element 4 is arranged in the inclined conveying portion 62, the tread 6 and the riser 8 in combination constitute a step which is similar to the conveying elements (steps) 53 of a conventional people conveyor/escalator 50 as it is shown in FIG. 1.

Each of the risers 8 comprises a first part 8a, which is rotatably connected by means of a first joint 9 to a first edge of a tread 6, and a second part 8b, which is rotatably connected by means of a second joint, which is not visible in the figures, to a second edge 6b of an adjacent tread 6. The first and second parts 8a, 8b of each riser 8 are connected to each other in a manner which allows them to linearly move/shift with respect to each other.

As a result, the treads 6 and the risers 8 form a continuous conveying band 2 which does not comprise any gaps. As the conveying band 2 does not comprise any gaps, the risk that any items or parts of a human body are trapped and/or squeezed between the elements of the conveying band 2 is considerably reduced. This enhances the safety of the people conveyor 50. Providing a conveying band 2 without any gaps further enhances the ride comfort of passengers using the people conveyor 50.

Tread rollers 10 are rotatably mounted to the second edge 6b of each tread 6. The tread rollers 10 are supported and guided by a tread roller guiderail 66 which extends along the conveying portion 62.

In the exemplary embodiment shown in the figures, the treads 6 are connected to a conveying chain 20 (see FIGS. 3 and 4), which extends parallel to the conveying band 2 between the two landing portions 51a, 51b. The conveying chain 20 corresponds to the step chain of a conventional people conveyor 50 and comprises a plurality of links 24, which are connected to each other by means of conveying chain bolts 26. Each of the conveying chain bolts 26 respectively supports a conveying chain roller 22. The conveying chain rollers 22 are supported and guided by a conveying chain roller guiderail 70 which extends parallel to the tread roller guiderail 66. The conveying chain roller guiderail 70 is shown only in FIG. 4.

A portion next to the first edge 6a of each tread 6 is supported by every third conveying chain bolt 26. Said portion in particular is provided with a bifurcated bearing structure 14, which is configured for accommodating a conveying chain bolt 26. The conveying chain 20 is in engagement with and driven by a sprocket 56. Although only one conveying chain 20 is shown in the figures, the skilled person will understand that two conveying chains 20, one conveying chain 20 extending on each lateral side of the conveying band 2, may be provided. The skilled person will further understand that the conveying chain 20 is an optional feature and that there are exemplary embodiments, in which the conveying band 2 is supported and driven directly by an appropriate drive, i.e. without providing and using a conveying chain 20.

In the return portion 64, which is shown in the lower part of FIGS. 2 and 3, respectively, the first and second parts 8a, 8b of the risers 8 are rotated into a position in which they are oriented basically parallel to the treads 6. Additionally, the second part 8b of each of the risers 8 is shifted over the corresponding first part 8a in order to compensate for the change in distance between two adjacent treads 6, which is accompanied with the rotation of the risers 8. In consequence, the treads 6 and the risers 8 are arranged as a flat band. As a result, the conveying band 2 occupies less space in the return portion 64 than in the conveying portion 62, in particular in a direction which is oriented orthogonal with respect to the conveying direction. The space which is occupied by the return portion 64 is also smaller than in a conventional conveyor 50, as it is illustrated in FIG. 1.

FIGS. 6 and 7 show schematic side views of the conveying band 2 extending in the first (lower) and second (upper) landing portions 51a, 51b and adjacent turnaround portions 57a, 57b, respectively.

FIGS. 6 and 7 illustrate the rotation of the first and second parts 8a, 8b of the risers 8 with respect to the treads 6 and their linear movement with respect to each other when the conveying elements 4 move from horizontal portions 81, 83 into the inclined conveying and return portions 62, 64 and vice versa.

FIGS. 6 and 7 in particular illustrate that the treads 6 in combination with the second parts 8b of the risers 8, which are shifted over the first parts 8a of the risers 8, form a continuous conveying surface in the horizontal portions 81, 83. Such a continuous conveying surface results in a safe and comfortable ride for the passengers.

The movement of the second part 8b of a riser 8 with respect to the first part 8a is shown in more detail in FIGS. 8a to 8c. The configuration shown in FIG. 8a corresponds to the basically vertically extending risers 8, in which the first and second parts 8a, 8c are arranged in-line with each other extending in a common plane. The configuration shown in FIG. 8c corresponds to the horizontal orientation of the risers 8, in which the second part 8b is shifted over the first part 8a. FIG. 8b depicts an intermediate configuration, in which the second part 8b is partially shifted over the first part 8a.

In an alternative configuration, which is not explicitly illustrated in the figures, the first and second parts 8a, 8b may be arranged in a telescopic configuration, in which the second part 8b is shifted into a cavity formed in the first part 8a.

FIGS. 6 and 7 further illustrate that due to the rotational movement of the risers 8 with respect to the treads 6, the conveying band 2 according to an exemplary embodiment of the invention needs less space in the turnaround portions 57a, 57b than a conventional band 52 of conveying elements 53 as it is shown in FIG. 1. As a result, the space needed for the turnaround portions 57a, 57b is reduced.

FIG. 9 shows a sectional side view of the conveying band 2 in one of the horizontal portions 81, 83 or in the return portion 64, and FIG. 10 shows a perspective view thereof.

FIGS. 9 and 10 in particular illustrate the flat conveying surface, which is provided by the combination of the tread surfaces 72 of the treads 6 and intermediate tread surfaces 74, which are provided by the second parts 8b of the risers 8 when they are arranged next and parallel to the tread surfaces 72 of the treads 6.

FIGS. 9 and 10 further illustrates that different guiderails 66, 70 are provided for supporting and guiding the tread rollers 10 and the conveying chain rollers 22, respectively. The skilled person understands that the orientation of the risers 8 with respect to the treads 6 is controlled by varying the vertical distance between the tread roller guiderail 66 and the conveying chain roller guiderail 70.

Cleats 71 may be formed on the tread surfaces 72, 74 of the treads 6 and the second parts 8b of the risers 8 in order to enhance the friction of the shoes of the passengers and for providing grooves which allow to discharge water from the tread surfaces 72, 74. Additional cleats 71 may be provided on the top surfaces of the first parts 8a and on the bottom surfaces of the second parts 8b of the risers 8. The cleats 71 formed on the risers 8 may engage with each other and/or with the cleats 71 formed on the treads 6 for guiding the first and second parts 8a, 8b when moving and for avoiding a long continuous gap extending between the treads 6 and the risers 8 over the width of the conveying elements 4. The cleats 71 further may engage with corresponding comb plates (not shown) provided at the landing portions 51a, 51b.

The flat orientation of the risers 8 in the turnaround portions 57a, 57b provides an additional free space between the conveying portion 62 and the return portion 64 of the conveying band 2. This allows to arrange the drive unit 54 including a motor and a gear in between the conveying portion 62 and the return portion 64 of the conveying band 2, as illustrated in FIG. 11. Electronic devices 55 including a controller and/or a frequency converter for driving the motor may by arranged in this space as well. Such a configuration allows to reduce the dimensions of the people conveyor 50, in particular in the longitudinal direction.

A people conveyor 50 according to an exemplary embodiment of the invention may be an escalator comprising two landing portions 51a, 51b with an inclined conveying portion 62 in between, as it is illustrated in FIGS. 1 and 2.

A conveying band 2 according to exemplary embodiments of the invention, however, further allows for advanced conveyor designs, in particular including people conveyors 50 comprising an almost arbitrary combination of horizontal and inclined portions.

As illustrated in FIG. 12, a people conveyor 50 according to an exemplary embodiment of the invention for example may comprise at least two extensive horizontal portions 81, 83, i.e. horizontal portions 81, 83 which are substantially longer than the horizontal portions which are usually provided next to the landing portions 51a, 51b of a conventional people conveyor 50, with an inclined portion 82 arranged in between. The horizontal portions 81, 83 in particular may have a length of up to 60 m, respectively, and the inclined portion 82 may be have an inclination angle of 30° to 35° spanning a vertical distance of up to 6 m.

The skilled person will understand that additional horizontal and/or inclined portions, which are not shown in FIG. 12, may be added to the left and right sides of the people conveyor 50 shown in FIG. 12. In addition to the conveying band 2, which is depicted only schematically, a handrail 90 is schematically shown in FIGS. 12 and 13.

A people conveyor 50 according to an exemplary embodiment of the invention may further comprise inclined portions 82, 84 having different, in particular opposite, inclinations. As illustrated in FIG. 13, a people conveyor 50 according to an exemplary embodiment of the invention for example may comprise a first horizontal portion 81 including a first landing portion 51a, followed by an adjacent first inclined (ascending) portion 82, which is followed by a second horizontal portion 83. A second inclined (descending) portion 84 is arranged next to the second horizontal portion 83, and is followed by a third horizontal portion 85, which includes the second landing portion 51b. Again, the skilled person will understand that additional horizontal and/or inclined portions, which are not shown, may be added to the left and right sides of the people conveyor shown in FIG. 13.

FIG. 14 illustrates the configuration of the conveying elements 4 when arranged in a descending portion 84 of the people conveyor 50.

When comparing the configuration of the conveying elements 4 in the descending portion 84 shown in FIG. 14 with the corresponding configuration in the ascending portion 82 (cf. FIGS. 3 and 4), it is noted that the positions of the guiderails 66, 70 respectively supporting and guiding the tread rollers 10 and the conveying chain rollers 22 are interchanged with respect to each other. I.e. while in the ascending portion 82 the tread roller guiderails 66 are arranged below the conveying chain roller guiderails 70 (cf. FIGS. 3 and 4), the tread roller guiderails 66 are arranged above the conveying chain roller guiderails 70 in the descending portion 84 (see FIG. 14).

As a result, the orientation of the risers 8 is changed so that in the descending portion 84 the second part 8b of each riser 8 is arranged above the first part 8a of the corresponding riser 8. However, the risers 8 in combination with the treads 6 still constitute steps, which are basically similar to the steps formed in the ascending portions 82 of the people conveyor 50.

While the terms “ascending” and “descending” have been used with respect to a conveying direction which is oriented from left to right in FIGS. 12 and 13, the skilled person will understand that a people conveyor 50 according to exemplary embodiments of the invention may be operated also in the opposite direction such that the conveying direction is oriented from right to left. In this case, it is apparent that the “ascending portion” will become the “descending portion” and the “descending portion” will become the “ascending portion”. Apparently, this change of the conveying direction has no influence in the functionality of the people conveyor 50.

A number of optional features are set out in the following. These features may be realized in particular embodiments, alone or in combination with any of the other features.

According to one embodiment the riser may be rotatably connected to a first tread and may be configured to be rotatably connected to an adjacent second tread. The riser in particular may be connected to the first and second treads by first and second joints, which allow for a rotating/pivoting motion between the riser and the respective tread. Such a configuration allows the riser to move between a first position, when arranged in an inclined portion of the conveying band, and a horizontal position in which the riser at least partly forms an intermediate tread when it is arranged in a horizontal portion of the conveying band.

According to one embodiment the tread and the riser may be configured to provide a continuous conveying surface in the at least one horizontal portion of the conveying band. A continuous conveying surface provides a safe and convenient riding experience to the passengers.

According to one embodiment the riser may comprise a first part, which is rotatably connected with the tread, and a second part, which is configured for being rotatably connected to an adjacent conveying element. The first and second parts in particular may be shiftably and/or rotatably connected with each other. Such a configuration allows the parts of the riser to compensate for any change of distance between adjacent conveying elements/treads when the riser moves from its inclined/vertical position into its horizontal position in which it provides an intermediate tread surface.

According to one embodiment the treads, the first and/or second parts may comprise a plurality of cleats, respectively. The cleats in particular may engage with each other for guiding the first and/or second part when they are moved with respect to each other and/or with respect to the tread. Engaging cleats allow for a controlled and guided movement of the two parts with respect to each other and/or with respect to the tread, respectively.

According to one embodiment the risers, when located in the at least one inclined portion, may be oriented at an angle of more than 0°, in particular at an angle of more than 45°, more particularly at an angle in the range from 80° to 90°, with respect to the treads. Such a configuration allows to closely mimic the configuration of a conventional escalator.

According to one embodiment the risers may at least partially overlap with the treads in the at least one horizontal portion. This allows to compensate for a reduced distance between adjacent treads in the at least one horizontal portion.

According to one embodiment the people conveyor may comprise a return portion,

with the conveying band also extending along the at least one return portion. In such a configuration, the risers may have the same configuration with respect to the treads as in the at least one horizontal portion. The risers in particular may at least partially overlap with the treads in the at least one return portion of the people conveyor. This allows to compensate for a reduced distance between adjacent treads in the return portion.

According to one embodiment the drive unit, which may include a motor and/or a gear for driving the conveying element, may be arranged between the conveying portion and the return portion of the conveying band. According to one embodiment electronic devices, in particular a controller and/or a frequency converter for driving the motor, may by arranged in this space as well. Due to the flat orientation of the risers in the turnaround portions, there is additional space available, which may accommodate components of the people conveyor. As a result, the extension of the people conveyor and in particular of the landing portions in the longitudinal direction may be reduced.

According to one embodiment the people conveyor may comprise a conveying chain (step chain), which is drivingly coupled to the conveying band, in particular to the treads of the conveying band. A conveying chain, which may be driven by a sprocket, provides a well suited means for effectively driving the conveying band.

According to one embodiment the people conveyor may comprise two horizontal portions, which in particular are configured as landing portions, and an inclined conveying portion, which extends between the two horizontal portions. Such a configuration is similar to the configuration of a conventional escalator. Thus, a people conveyor according to such an embodiment of the invention may be employed as an escalator which does not comprise any gaps between adjacent steps or treads.

According to one embodiment the people conveyor may comprise at least two inclined conveying portions and at least one horizontal portion extending between the at least two inclined conveying portions. The at least two inclined conveying portions in particular may be inclined in the same directions, such as upward/upwards or downwards/downwards and/or in opposite directions upwards/downwards or downwards/upwards with respect to the at least one horizontal portion. This allows for new conveyor designs; it in particular allows to form a bridge comprising at least one upward portion, at least one horizontal portion and at least one downward portion using only a single conveying band.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

2 conveying band
4 conveying element
6 tread
6a first edge of the tread
6b second edge of the tread
7 reinforcement rib
8 riser
8a first part of the riser
8b second part of the riser
9 joint
10 tread roller
14 bearing structure
20 conveying chain
22 conveying chain roller
24 link of the conveying chain
26 conveying chain bolts
50 people conveyor
51a first landing portion
51b second landing portion
52 conventional conveying band (prior art)
53 conventional conveying elements/steps (prior art)
54 drive unit
55 electronic devices
56 sprocket
57a, 57b turnaround portions
58 transmission element
60 rotating shaft
62 conveying portion
64 return portion
66 tread roller guiderail
70 conveying chain roller guiderail
71 cleats
72 tread surface
74 intermediate tread surface
81 horizontal portion
82 inclined portion
83 horizontal portion
84 inclined portion
85 horizontal portion
90 handrail

1. A conveying element (4) to be employed in a conveying band (2) of a people conveyor (50) comprising at least one horizontal portion (81, 83, 85), the conveying element (4) comprising:
a tread (6); and
a riser (8);
wherein the conveying element (4) is configured such that the riser (8) at least partly forms an intermediate tread surface (74) in the at least one horizontal portion (81, 83, 85).

2. The conveying element (4) according to claim 1, wherein the riser (8) is rotatably connected to the tread (6) and is configured to be rotatably connected to an adjacent conveying element (4), in particular to a tread (6) of an adjacent conveying element (4).

3. A conveying element (4) which is to be employed in a conveying band (2) of a people conveyor (50), the conveying element (4) comprising:
a tread (6); and
a riser (8);
wherein the riser (8) is rotatably connected to the tread (6) and is configured to be rotatably connected to an adjacent conveying element (4), in particular to a tread (6) of an adjacent conveying element (4).

4. The conveying element (4) according to claim 1, wherein the riser (8) is rotatably connected to the adjacent conveying element (4) by means of at least one joint (9).

5. The conveying element (4) according to claim 1, wherein the tread (6) and the riser (8) are configured to provide a continuous tread surface (72, 74) in the at least one horizontal portion (81, 83, 85).

6. The conveying element (4) according to claim 1, wherein the riser (8) comprises a first part (8a), which is rotatably connected with the tread (6), and a second part (8b), which is configured to be rotatably connected to an adjacent conveying element (4).

7. The conveying element (4) according to claim 6, wherein the first and second parts (8a, 8b) are shiftably and/or rotatably connected with each other.

8. The conveying element (4) according to claim 6, wherein the tread (6) and/or the first and second parts (8a, 8b) respectively comprise cleats (71), wherein the cleats (71) in particular engage with each other for guiding the first and/or second parts (8a, 8b) when moving.

9. A conveying band (2) of a people conveyor (50) comprising a plurality of conveying elements (4) according to claim 1, wherein the conveying elements (4) are rotatably connected with each other.

10. A people conveyor (50) comprising
at least one horizontal portion (81, 83, 85);
at least one inclined portion (82, 84); and
a conveying band (2) according to claim 9 extending along the at least one horizontal portion (81, 83, 85) and the at least one inclined portion (82, 84).

11. The people conveyor (50) according to claim 10, wherein the risers (8) at least partially overlap with the treads (6) in the at least one horizontal portion (81, 83, 85).

12. The people conveyor (50) according to claim 10 or 11 further comprising at least one return portion (64), wherein the conveying band (2) also extends along the at least one return portion (64) and wherein the risers (8) have the same configuration with respect to the treads (6) as in the at least one horizontal portion (81, 83, 85).

13. The conveying band (2) according to claim 12, wherein a drive unit (54) in particular including a motor, which is configured for driving the conveying band (2), and/or electronic devices (55) are arranged in between a conveying portion (62) of the conveying band (2) and the return portion (64) of the conveying band (2).

14. The people conveyor (50) according to claim 10 further comprising a conveying chain (20), which is drivingly coupled to the conveying band (2), in particular to the treads (6).

15. The people conveyor (50) according to claim 10 comprising
at least two horizontal portions (81, 83, 85), which in particular are configured as landing portions, and at least one inclined portion (82, 84) extending between two of the two horizontal portions (81, 83, 85); and/or
at least two inclined portions (82, 84) and at least one horizontal portion (83) extending between the at least two inclined portions (82, 84), wherein the at least two inclined portions (82, 84) in particular are inclined in the same directions and/or in opposite directions with respect to the at least one horizontal portion (83).
